(19) United States
(12) Patent Application Publication
(10) Pub. No.: US 2008/0214269 A1
(43) Pub. Date: Sep. 4, 2008

(54) Gaming Machine Capable Of Operating To Indicate The Number Of Bets, And Game Playing Method

(75) Inventor: Kazumasa Yoshizawa, Tokyo (JP)

Correspondence Address: NDQ&M WATCHSTONE LLP, 1300 EYE STREET, NW, SUITE 1000 WEST TOWER, WASHINGTON, DC, 20005, US

(73) Assignee: Aruze Corp., Tokyo (JP)

(21) Appl. No.: 12/040,178

(22) Filed: Feb. 29, 2008

(30) Foreign Application Priority Data
Mar. 1, 2007 (JP) JP2007-051845

(51) Int. Cl. A63F 13/00; G06F 17/00

(52) U.S. Cl. 463/17

(57) ABSTRACT

Roulette is executed by placing a bet using a bet screen 70 displayed on a liquid crystal display 10. On the bet screen 70 is provided a bet-with-a-bonus button 201 in addition to an ordinary bet button 75. When the amount of bets is indicated using the bet-with-a-bonus button 201, a game which is separate from Roulette is executed as a bonus game subsequent to Roulette, and the player is awarded a bonus payout based on an outcome of the bonus game. The odds when the amount of bets is indicated using the bet-with-a-bonus button 201 is set to be lower than the odds indicated using only the ordinary bet button 75.

### CROSS-REFERENCE TO RELATED APPLICATIONS

This application is based upon and claims a priority from the prior Japanese Patent Application No. 2007-051845 filed on Mar. 1, 2007, the entire contents of which are incorporated herein by reference.

### BACKGROUND OF THE INVENTION

1. Field of the Invention

This disclosure relates to a gaming machine capable of operating to indicate the number of bets, and a game playing method.

2. Description of Related Art

Conventionally, with games in which a side bet game is executed together with a main game, an operation of indicating the number of bets for the side bet game has been performed separately from an operation of indicating the original number of bets for the main game. Additionally, with the side bet game, it has been determined whether or not to award a bonus payout to a player thereof according to a game outcome in the main game. Furthermore, the determination to award the bonus payout to the player in the side bet game was based on a condition that a low-probability outcome is realized in the main game, since the bonus payout is relatively high (see, for example, U.S. Pat. No. 6,789,801B2, U.S. Pat. No. 5,711,525 and. U.S. Pat. No. 6,874,786B2).

In the above manner, however, an opportunity for the player to be awarded the bonus payout in the side bet game is rare. Furthermore, in order to participate in the side bet game, it is necessary, as stated above, to take the trouble of indicating the number of bets for the side bet game, quite separately from indicating the original number of bets for the main game. Thus, there has been a trend that the player of the main game, who is discouraged by the above situation, will not willingly attempt to be awarded the bonus payout in the side bet game, and recedes from the side bet game.

### SUMMARY OF THE INVENTION

An object of the disclosure is to provide an unprecedented, novel gaming machine and game playing method by adjusting the main game and the bonus payout lottery through a one-time indication of the number of bets.

To achieve the object of the disclosure, there is provided a gaming machine, comprising: a display device for displaying a ball used in a main game, a wheel including a plurality of pockets where a number is marked respectively and the ball is fallen, and an odds table including a plurality of bet spots, on which the numbers marked on the pockets are marked respectively; an operation unit for allowing a player to indicate the number of bets of one of a first type and a second type for any of the bet spots; a memory for storing the number of credits held by the player; and a processor programmed to execute the main game by executing processes of: when the number of bets of the first type is indicated by an operation on the operation unit, (a) displaying on the display device that the ball is thrown onto the spun wheel and is fallen into one of the pockets, upon completion of the player's performing the operation of indicating the number of bets using the operation unit; (b) determining whether or not the player side wins, based on the number which is marked on the pocket into which the ball is fallen which have been displayed on the display device; and (c) if it is determined that the player side wins, adding the number of credits calculated using a predefined odds to the number of credits in the memory and storing the sum, when, otherwise, the number of bets of the second type is indicated by an operation on the operation unit, (d) changing the odds to a lower value than the predefined odds and executing the main game; (e) randomly determining whether or not to award a bonus to the player; and (f) if it is determined to award the bonus to the player, adding the number of credits according to the bonus to the number of credits in the memory and storing the sum.

Furthermore, according to another aspect, there is provided a game playing method comprising, so as to make a main game proceed, the steps of: when a player indicates the number of bets of a first type for any of a plurality of bet spots included on an odds table, (a) throwing a ball onto a spun wheel and being fallen into one of pockets of the wheel, upon completion of the player's indicating the number of bets; (b) determining whether or not the player side wins, based on a number which is marked on the pocket into which the ball is fallen; and (c) if it is determined that the player side wins, awarding the number of credits calculated using a predefined odds to the player, when, otherwise, the player indicates the number of bets of the second type for any of a plurality of bet spots included on the odds table, (d) changing the odds to a lower value than the predefined odds and executing the main game; (e) randomly determining whether or not to award a bonus to the player; and (f) if it is determined to award the bonus to the player, awarding the number of credits according to the bonus to the player.

### BRIEF DESCRIPTION OF THE DRAWINGS

FIG. 1 is an explanatory view showing a bet screen displayed on a liquid crystal display of a terminal according to a present embodiment;

FIG. 2 is an outline view of a roulette gaming machine according to the present embodiment;

FIG. 3 is an outline view of the terminal according to the present embodiment;

FIG. 4 is a block diagram schematically showing a control system of the roulette gaming machine according to the present embodiment;

FIG. 5 is a block diagram schematically showing a control system of the terminal according to the present embodiment;

FIG. 6 is an explanatory view showing a betting board or the like displayed on a bet screen on the liquid crystal display of the terminal according to the present embodiment;

FIG. 7 is an explanatory view showing a wheel or the like displayed on the bet screen on the liquid crystal display of the terminal according to the present embodiment;

FIG. 8 is an explanatory view showing the bet screen displayed on the liquid crystal display of the terminal according to the present embodiment;

FIG. 9 is an explanatory view showing the betting board displayed on the bet screen on the liquid crystal display of the terminal according to the present embodiment;

FIG. 10 is an explanatory view showing the bet screen displayed on the liquid crystal display of the terminal according to the present embodiment;

FIG. 11 is an explanatory view showing the betting board displayed on the bet screen on the liquid crystal display of the terminal according to the present embodiment;

FIG. 12 is an explanatory view showing the bet screen displayed on the liquid crystal display of the terminal according to the present embodiment;

FIG. 13 is an explanatory view showing a main screen displayed on a front display according to the present embodiment;

FIG. 14 is a flow chart of a game processing program in the roulette gaming machine according to the present embodiment;

FIG. 15 is a flow chart of a game processing program in the roulette gaming machine according to the present embodiment;

FIG. 16 is an explanatory view showing the bet screen at a bonus game displayed on the liquid crystal display of the terminal according to the present embodiment;

FIG. 17 is an explanatory view showing the betting board at the bonus game displayed on the bet screen on the liquid crystal display of the terminal according to the present embodiment;

FIG. 18 is a flow chart of a game processing program in the roulette gaming machine according to the present embodiment;

FIG. 19 is a flow chart of a game processing program in the roulette gaming machine according to the present embodiment;

FIG. 20 is a flow chart of a game processing program in the roulette gaming machine according to the present embodiment;

FIG. 21 is a flow chart of a game processing program in the roulette gaming machine according to the present embodiment;

FIG. 22 is a table showing the difference between an ordinary bet operation and a bet-with-a-bonus operation; and

FIG. 23 is a schematic view of an exemplary application of the present invention to a table game.

### DETAILED DESCRIPTION OF THE PREFERRED EMBODIMENTS

In the following, a multi-player roulette gaming machine according to the present invention will be described in detail referring to the drawings based on an embodiment implemented on a roulette gaming machine. Here, the roulette gaming machine according to the present embodiment is one type of multi-player gaming machines comprising a plurality of terminals for accepting inputs from the players and executes European roulette, which is a kind of roulette games.

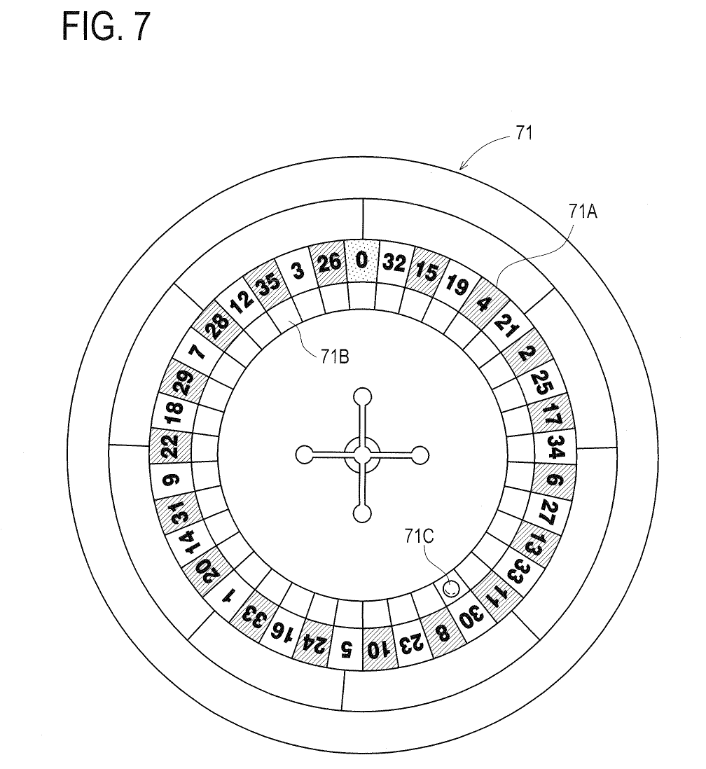

Here, for example, European roulette (abbreviated to simply “Roulette” hereafter) is a game with the wheel 71A of the type that there is not a pocket 71B marked “00”, as shown FIG. 7. In Roulette, each player first expects the pocket 71B into which the ball 71C is fallen and bets a certain amount of chips on the pocket 71B into which the ball 71C is fallen. Then the ball 71C is thrown by a dealer onto the spun wheel 71A, the pocket 71B which the player bets are compared with the pocket 71B into which the ball 71C is fallen actually on the spun wheel 71A to determine the win or loss. If the player's bet target is a number or a color relating to the pocket 71B into which the ball 71C is fallen actually, it is determined that the player has won the game, and a payout is made according to the amount of bets.

Here, a plurality of types of method indicating the bet target, in other words, types of method placing the chips are well known, their explanation is omitted here. The roulette gaming machine according to the present invention may execute only European roulette but also American roulette or Mexican roulette.

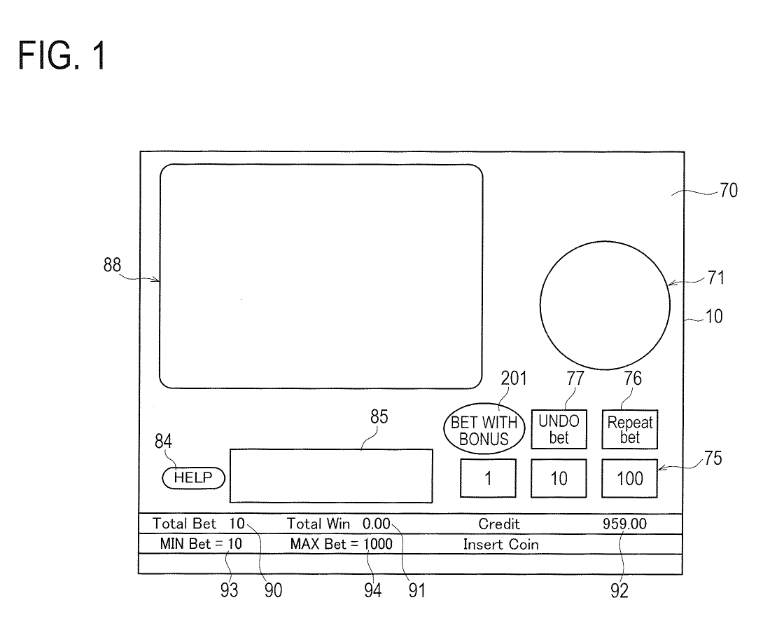

The roulette gaming machine according to the present invention has, in addition to an ordinary bet button 75, a bet-with-a-bonus button 201, such as a bet screen particularly shown in FIG. 1. When the amount of bets is indicated by both the bet-with-a-bonus button 201 and the bet button 75, a game which is separate from Roulette is executed as a bonus game subsequent to Roulette, and a bonus payout is awarded to the player based on an outcome of the bonus game.

Here, odds are associated with a place for the chips (a bet spot), respectively. However, the odds when the amount of bets is indicated by both the bet-with-a-bonus button 201 and the bet button 75 is set to the odds (an ordinary value), when the amount of bets is indicated only by the bet button 75, of x0.7. In other words, the odds when the amount of bets is indicated by both the bet-with-a-bonus button 201 and the bet button 75 is set to be lower than the odds when the amount of bets is indicated only by the bet button 75.

For example, if the player bets on the pocket 71B marked “5” (Straight), the odds is 36 times when the amount of bets is indicated only by the bet button 75, otherwise, the odds is 25.2 times (=36 times x0.7) when the amount of bets is indicated by both the bet-with-a-bonus button 201 and the bet button 75, which is set be lower than the odds (36 times) when the amount of bets is indicated only by the bet button 75. If the player bets on the pockets 71B marked “5” “29” (Split), the odds is 18 times when the amount of bets is indicated only by the bet button 75, otherwise, the odds is 12.6 times (=18 times x0.7) when the amount of bets is indicated by both the bet-with-a-bonus button 201 and the bet button 75, which is set be lower than the odds (18 times) when the amount of bets is indicated only by the bet button 75. Furthermore, if the player bets on the pockets 71B colored “Red” (Even Money Bets), the odds is 2 times when the amount of bets is indicated only by the bet button 75, otherwise, the odds is 1.4 times (=2 times x0.7) when the amount of bets is indicated by both the bet-with-a-bonus button 201 and the bet button 75, which is set be lower than the odds (2 times) when the amount of bets is indicated only by the bet button 75.

In the following, for simplicity of description, the phrase “when the amount of bets is indicated by both the bet-with-a-bonus button 201 and the bet button 75” may be occasionally expressed, for example, “when the amount of bets is indicated using the bet-with-a-bonus button 201”.

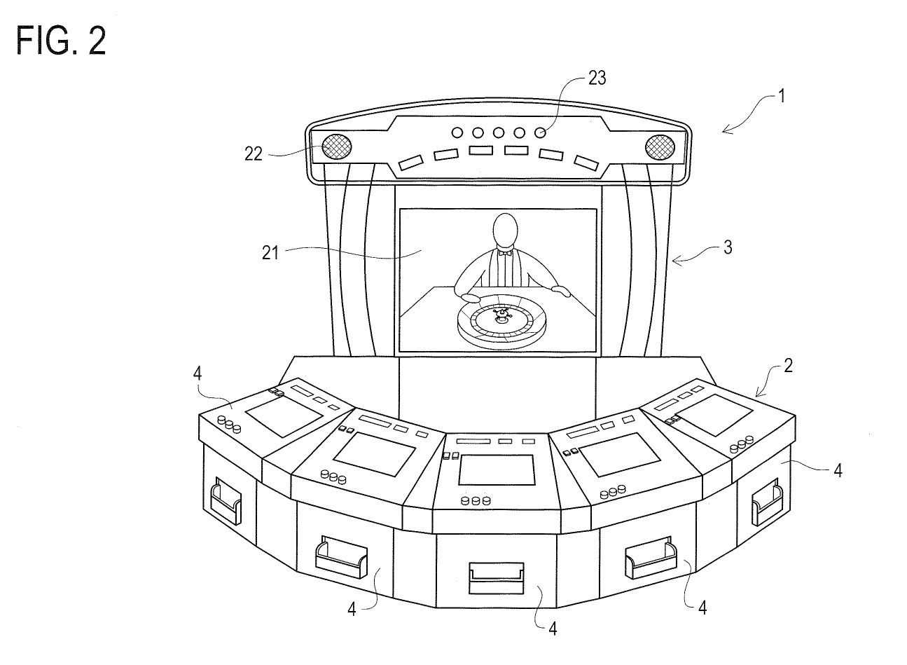

First, a structural overview of the roulette gaming machine 1 according to the present embodiment will be described, referring to FIG. 2. FIG. 2 is an outline view of the roulette gaming machine 1 according to the present embodiment.

The roulette gaming machine 1 according to the present embodiment generally comprises a table unit 2 at which the player sits and plays the game, and a panel unit 3 provided behind the table unit 2 to display animation images of the dealer.

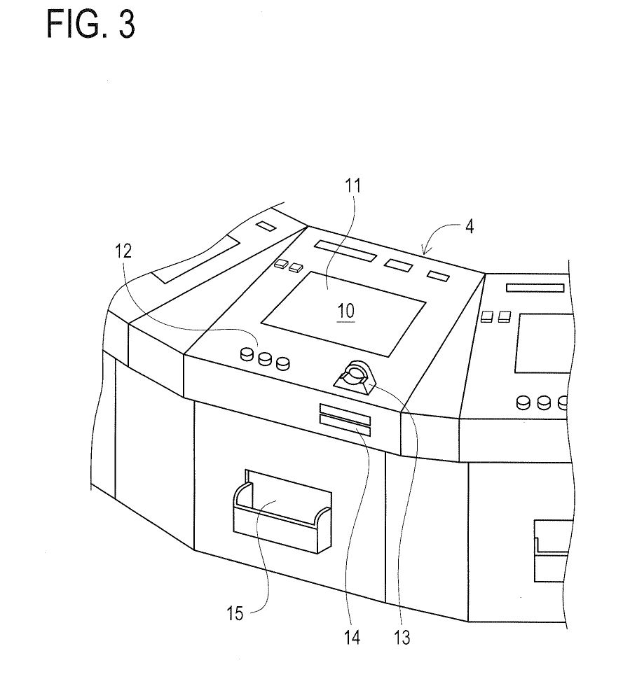

First, the table unit 2 will be described below. The table unit 2 has a plurality (five in FIG. 2) of terminals 4 referred to as satellites arranged in generally a fan-like manner. Here, FIG. 3 is an outline view of a terminal 4 according to the present embodiment.

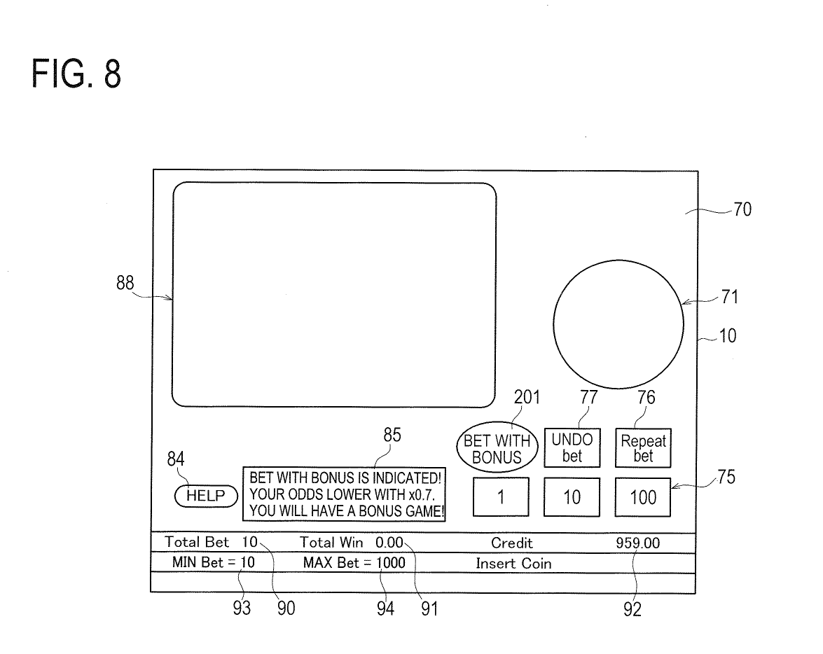

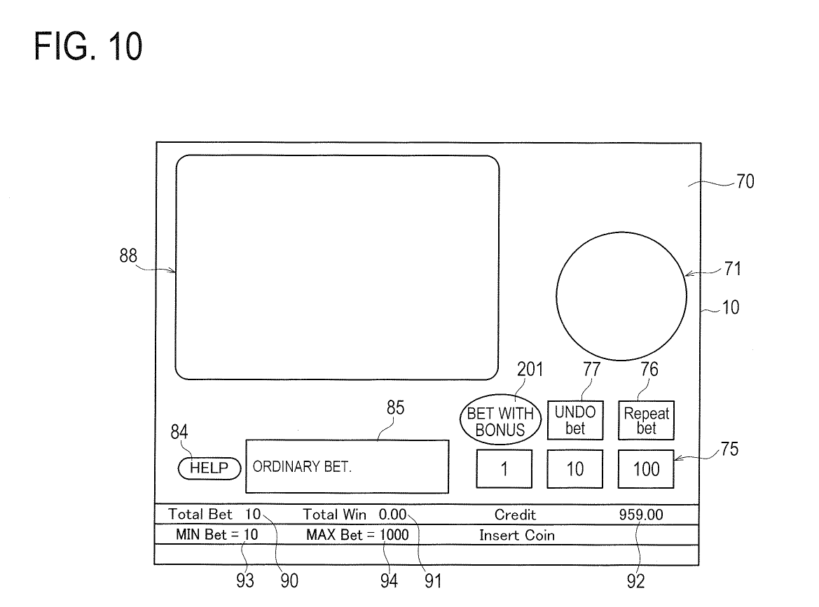

As shown in FIG. 3, the terminal 4 comprises a liquid crystal display 10 for displaying the bet screen (see FIGS. 8 and 10) described below and the game outcome or the like, a touch panel 11 provided on the front face of the liquid crystal display 10 and used for selecting the buttons which are displayed on the liquid crystal display 10 when selecting the bet target and indicating the amount of bets, an operation button 12 for performing a payout operation, a coin insertion slot 13 for inserting coins or medals, a bill insertion slot 14 for inserting bills, and a coin payout opening 15 for paying out, to the player, coins or medals corresponding to the accumulated credits when a payout operation is performed.

Referring to FIG. 2 again, the panel unit 3 comprises a front display 21, speakers 22 provided on the upper part of the front display 21 for outputting music or sound effects along the progress of the game, and LEDs 23 which light up when a variety of effects are performed. With regard to this, the front display 21 displays images of the dealer who is spinning the wheel 71A in one direction and spinning the ball 71C in the opposite direction or delivering the chips. Furthermore, the front display 21 displays images of the ball 71C which eventually is falling onto the wheel 71A and into the pocket 71B or the like.

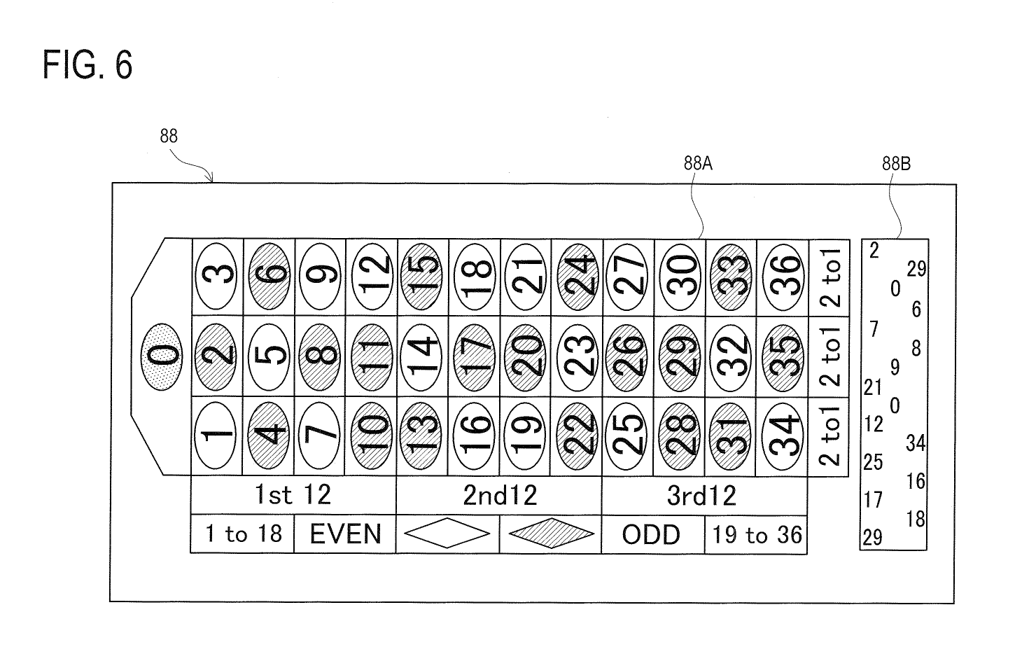

Here, as stated above, because the roulette gaming machine 1 according to the present embodiment executes European roulette, there is no pocket marked “00” on the wheel 71A and a betting board 88A (see FIG. 6) used in the roulette gaming machine 1 according to the present embodiment.

Next, a playing method of Roulette in the roulette gaming machine 1 arranged as above will be described, wherein the player who is going to play the game sits in front of the terminal 4 and places a desired amount of bets using the bet screen displayed on the liquid crystal display 10. On the other hand, the images of the ball 71C, which is thrown by the dealer onto the spun wheel 71A and eventually falling into one of the pockets 71B, are displayed on the front display 21 and each of the liquid crystal displays 10. Furthermore, if the player wins for the bet, credits multiplied the odds of the player's bet target by the amount of bets (number of credits) which has been placed is provided as an award at each of the terminals 4. However, as stated above, if the amount of bets is indicated by both the bet-with-a-bonus button 201 and the bet button 75, credits 0.7 times the number of credits multiplied the odds of the player's bet target by the amount of bets (number of credits) which has been placed is provided as an award. On the other hand, no award is provided if the player loses for the bet. Additionally, when the amount of bets is indicated by both the bet-with-a-bonus button 201 and the bet button 75 in particular, a game separate from Roulette is executed as the bonus game subsequent to Roulette, regardless of the player's winning, or losing in Roulette, and a bonus payout is awarded to the player based on the outcome of the bonus game.

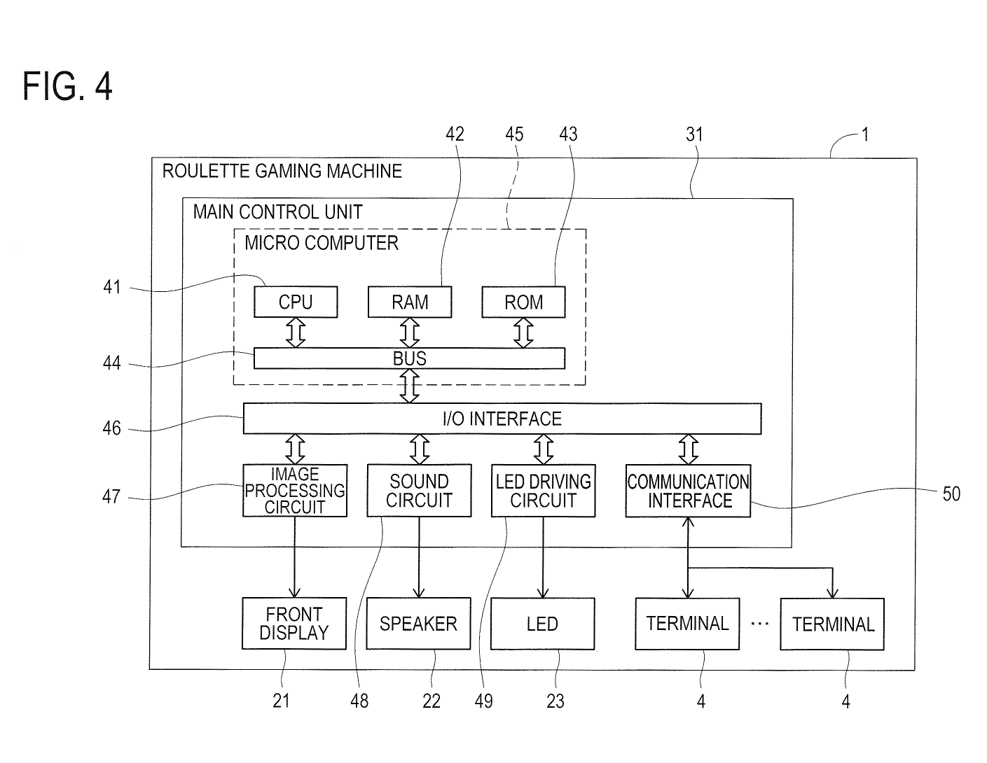

Next, the arrangement related to a control system of the roulette gaming machine 1 will be described, referring to FIG. 4. FIG. 4 is a block diagram schematically showing the control system of the roulette gaming machine 1 according to the present embodiment.

The roulette gaming machine 1 according to the present embodiment comprises, as shown in FIG. 4, a main control unit 31, a plurality of terminals 4 connected to the main control unit 31, and a variety of peripheral devices.

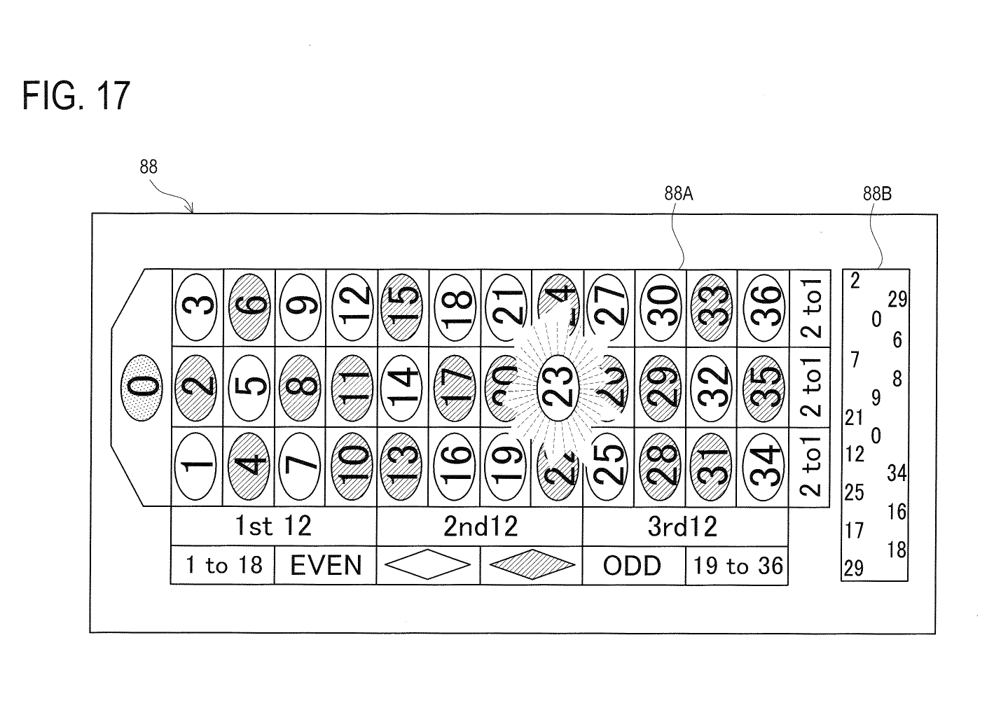

The main control unit 31 is generally composed of a micro-computer 45 as the kernel comprising a CPU 41, a RAM 42, a ROM 43 and a bus 44 for transferring data mutually between these elements. The ROM 43 stores a variety of programs, data tables or the like for executing necessary processes to control the roulette gaming machine 1. The RAM 42 is a memory for temporarily storing a variety of data which have been operated in the CPU 41. Furthermore, the ROM 43 also stores image data of the wheel 71A, the betting board 88A, and the ball 71C or the like. Particularly, with the roulette gaming machine 1 according to the present embodiment, a game which is separate from Roulette may be executed as the bonus game subsequent to Roulette as stated above, in which case the image data of the betting board 88A used in the bonus game is also stored (see FIG. 17).

In addition, the CPU 41 is connected, via an I/O interface 46, to an image processing circuit 47, a sound circuit 48, an LED driving circuit 49, and a communication interface 50.

The main control unit 31 receives player's bet operation information related to the amount of bets from each of the terminals 4 and determines whether or not a condition is realized to start Roulette. Then, upon starting Roulette, the main control unit 31 assigns, based on a lottery result, one of numbers which are respectively marked on the pockets 71B of the wheel 71A to the result of the lottery (on the display screen, the ball 71C on the spun wheel 71A is falling into the pocket 71B which is marked the assigned number). As the result, the win or loss (either the player has won or lost) is determined based on the pocket 71B into which the ball 71C is fallen, and the main control unit 31 transmits the result of determination to each of the terminals 4. Subsequently, each of the terminals 4 increases or decreases the accumulated credits according to the result of win or loss received from the main control unit 31.

Furthermore, the main control unit 31 identifies the terminal 4 at which the player's bet operation has been performed on both the bet-with-a-bonus button 201 and the bet button 75 according to the bet operation information received from each of the terminals 4. Regardless of the win or loss result of Roulette, the main control unit 31, for the identified terminal 4, draws, based on a lottery result, a number out of 37 numbers of within the range of 0 to 36 (on the display screen, the drawn number is shining on the betting board 88A). The main control unit 31 transmits the lottery result for the bonus game to the terminal 4. Subsequently, based on the lottery result for the bonus which is received from the main control unit 31, the terminal 4 increases the accumulated credits by amount of the bonus payout.

In addition, the main control unit 31 also outputs image signals to be displayed on the front display 21, and controls driving of the speakers 22 and the LEDs 23.

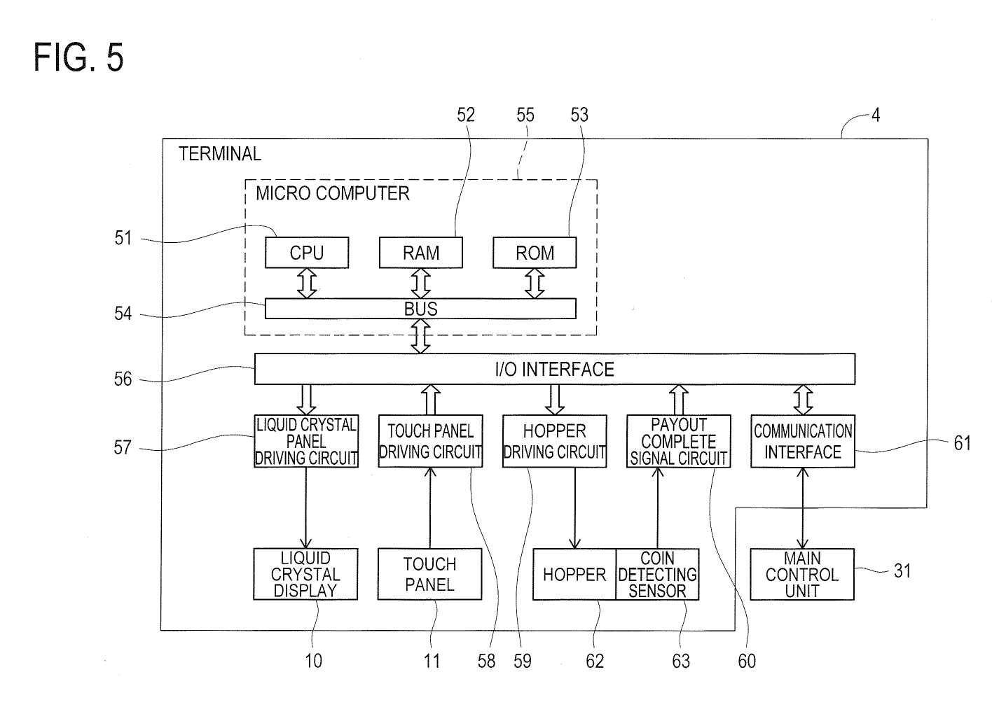

Next, the arrangement related to a control system of the terminal 4 will be described, referring to FIG. 5. FIG. 5 is a block diagram schematically showing the control system of the terminal 4 according to the present embodiment.

The terminal 4 according to the present embodiment is generally composed of a microcomputer 55 as the kernel comprising a CPU 51, a RAM 52, a ROM 53 and a bus 54 for transferring data mutually between these elements, as shown in FIG. 5. ROM 43 includes a variety of programs, data tables or the like stored therein for executing necessary processes to control the terminal 4. The RAM 52 is a memory for temporarily storing a variety of data which have been operated in the CPU 51, such as the number of credits (that is, the number of credits held by the player at the terminal 4) currently accumulated on the terminal 4, the bet target on which the player placed a bet, the bet type (whether or not the bet-with-a-bonus button 201 has been used), the amount of bets (number of credits) which has been placed on the bet target or the like.

In addition, the CPU 51 is connected, via an I/O interface 56, to a liquid crystal panel driving circuit 57, a touch panel driving circuit 58, a hopper driving circuit 59, a payout complete signal circuit 60, and a communication interface 61. Furthermore, a liquid crystal display 10 is connected to the liquid crystal panel driving circuit 57, a touch panel 11 is connected to the touch panel driving circuit 58, a hopper 62 is connected to the hopper driving circuit 59, and a coin detecting sensor 63 is connected to the payout complete signal circuit 60, respectively. Additionally, the main control unit 31 is connected to the communication interface 61.

Based on operation information which is output from the touch panel 11, the CPU 51 calculates the amount of bets (number of credits) placed by the player and identifies the player's bet target, then, together with information about whether or not the bet operation has been performed using the bet-with-a-bonus button 201 (type of bet), stores them into the RAM 52 and transmits them to the main control unit 31. Furthermore, the CPU 51 increases or decreases the accumulated credits according to the win or loss transmitted from the main control unit 31. Additionally, when the player has performed the bet operation using the bet-with-a-bonus button 201, the CPU 51 increases the accumulated credits according to the lottery result for the bonus transmitted from the main control unit 31.

In addition, the CPU 51 also outputs image signals to be displayed on the liquid crystal display 10, and controls payout of coins from the coin payout opening 15 by the hopper 62 and the coin detecting sensor 63.

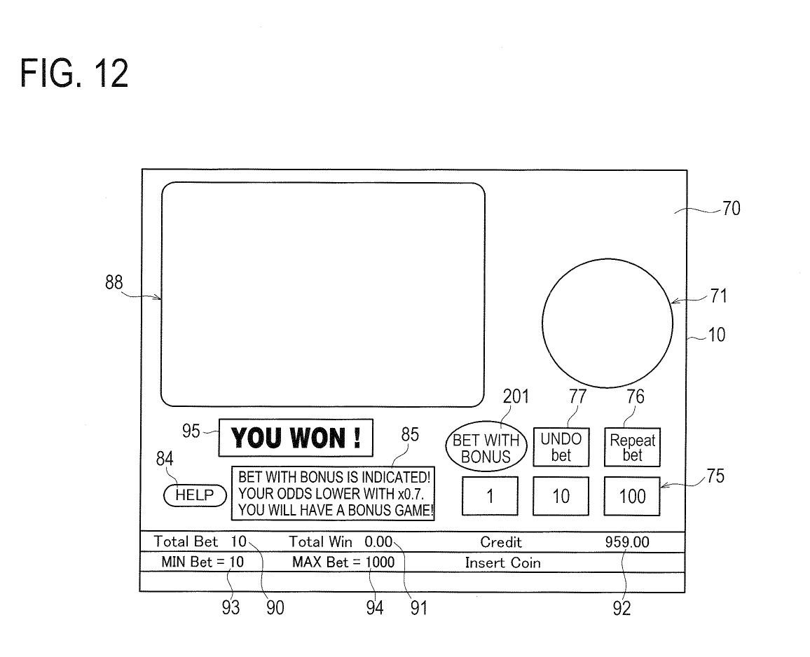

Next, a bet screen 70 which is displayed on the liquid crystal display 10 of the terminal 4 when Roulette is played on the roulette gaming machine 1 according to the present embodiment will be described, referring to FIG. 1, FIG. 8, FIG. 10 and FIG. 12. FIG. 1, FIG. 8, FIG. 10 and FIG. 12 are diagrams showing the bet screen 70 displayed on the liquid crystal display 10 of the terminal 4. Here, with the roulette gaming machine 1 according to the present embodiment, the player uses the bet screen 70 and the touch panel 11 to perform a bet operation of placing a certain amount of credits. With regard to this, the bet operation includes an ordinary bet operation which is performed only on the bet button 75 without using the bet-with-a-bonus button 201, and a bet-with-a-bonus operation which is performed on both the bet-with-a-bonus button 201 and the bet button 75.

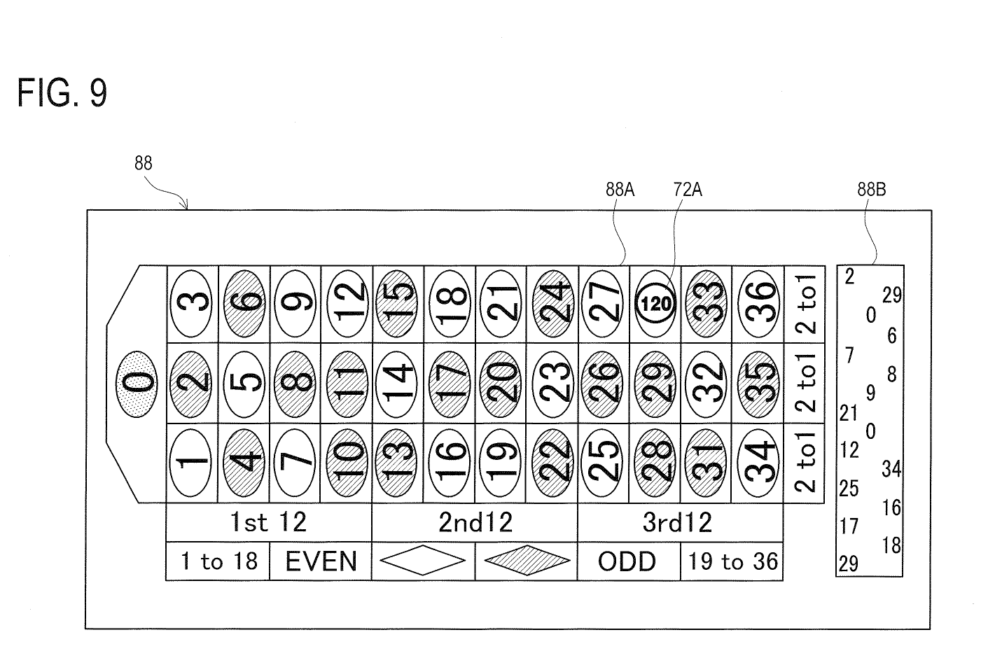

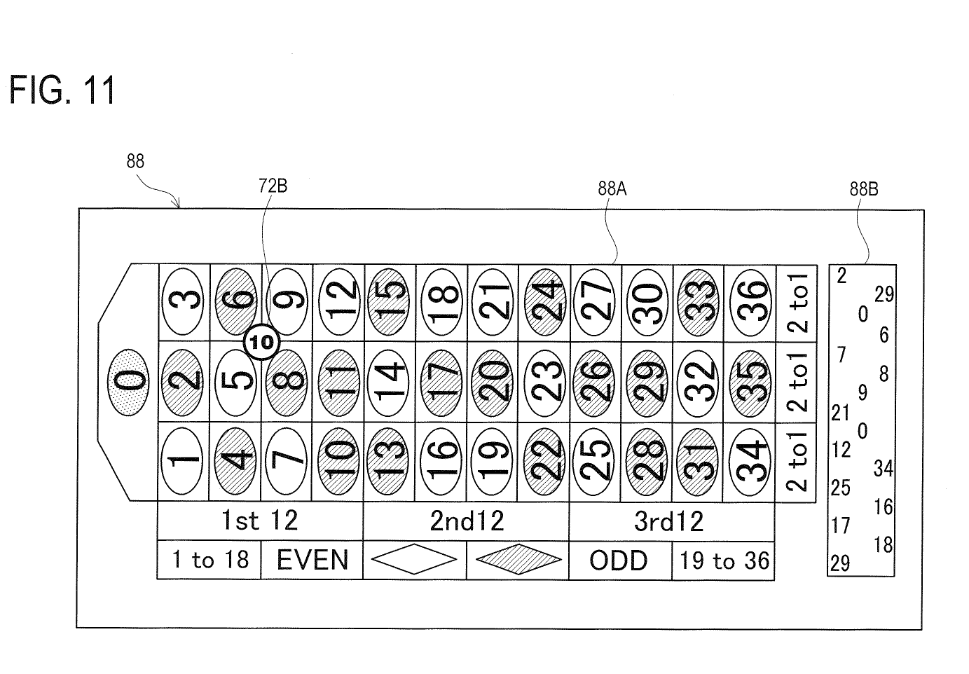

As shown in FIG. 1, FIG. 8, FIG. 10 and FIG. 12, the bet screen 70 comprises a wheel display area 71 for displaying the wheel 71A onto which the thrown ball 71C is fallen into one of the pockets 71B, a chip display area 88 for displaying a image 72 (see FIGS. 9 and 11) of the chips which have been bet, and an information display area for displaying a variety of operation buttons and information of the player. With regard to this, the chip display area 88 displays the betting board 88A and a result history of roulette 88B (see FIG. 6).

Here, the image 72 of chips (see FIGS. 9 and 11) includes an image 72A of chips (see FIG. 9) which is displayed for a bet-with-a-bonus operation performed on both the bet-with-a-bonus button 201 and the bet button 75, and an image 72B of chips (see FIG. 11) which is displayed for an ordinary bet operation performed only on the bet button 75 without using the bet-with-a-bonus button 201. With regard to this, both images 72A and 72B of chips are distinctly displayed using different colors or the like, although not shown.

Here, the wheel display area 71 displayed a series of images. In the series of images, the wheel 71A is spinning, the ball 71C is thrown, the ball 71C is falling into one of the pockets 711B, and the wheel 71A is stopping.

Here, the chip display area 88 displays the betting board 88A and the result history of roulette 88B shown in FIG. 6, FIG. 9 and FIG. 11. The betting board 88A is displayed a plurality of bed squares relating to the numbers or the colors which are marked on or colored to the pockets 71B of the wheel 71A. The player then determines the player's bet target by touching any of the bed squares in the chip display area 88. The terminal 4 transmits the determined player's bet target to the main control unit 31. The result history of roulette 88B displays 16 numbers that are marked on the pockets 71B into which the ball 71C were fallen in 16 past games until the last time.

In the chip display area 88, the betting board 88A displays the image 72 of chips corresponding to the amount of bets placed by the player (for example, chips corresponding to 120 credits are bet in FIG. 9 and chips corresponding to 10 credits are bet in FIG. 11). The player then selects the amount of bets using the bet button 75, determines the amount of bets by touching the chip display area 88. The terminal 4 transmits the determined amount of bets to the main control unit 31.

In addition, a plurality of the bet buttons 75 (three in the present embodiment, i.e., “one credit”, “10 credits”, and “100 credits”) are provided on the lower right hand side of the chip display area 88. Then, the player can select the amount of bets to be placed in the current game by touching the bet button 75.

Additionally, the bet-with-a-bonus button 201 is provided above the bet button 75. The player can indicate the amount of bets using the bet button 75 as a bet-with-a-bonus operation by touching the bet-with-a-bonus button 201 once.

However, if the amount of bets is indicated by using only the bet button 75 without touching the bet-with-a-bonus button 201, the operation turns out to be an ordinary bet operation.

Furthermore, a Repeat bet button 76 and an UNDO bet button 77 are provided above the bet button 75. The player can place a bet which is the same amount of bets as the previous game by touching the Repeat bet button 76. In addition, a bet operation performed once can be canceled by touching the UNDO bet button 77. Furthermore, a bet-with-a-bonus operation can be canceled by touching the UNDO bet button 77.

In addition, a HELP button 84 is provided on the lower side of the chip display area 88. The HELP button 84 is a button to be touched when displaying operation instructions of the roulette gaming machine 1 on the liquid crystal display 10. Additionally, a message area 85 for displaying messages that support the progress of game is provided on the right hand side of the HELP button 84.

On the message area 85, messages such as “BET WITH BONUS IS INDICATED! YOUR ODDS LOWER WITH x0.7. YOU WILL HAVE A BONUS GAME!” are displayed, as shown in FIG. 8 or 12 while a bet-with-a-bonus operation is being performed. While, on the other hand, an ordinary bet operation is being performed, a message such as “ORDINARY BET.” is displayed, as shown in FIG. 10.

At the lower part of the bet screen 70, a bet amount display area 90 for displaying the amount of bets currently placed by the player, an acquisition amount display area 91 for displaying the amount provided to the player as an award in the game, a held credit display area 92 for displaying the number of credits currently held by the player, a lower-limit-of-bet-amount display area 93 displaying the lower limit of the amount of bets that can be placed by the player, and an upper-limit-of-bet-amount display area 94 displaying the upper limit of the amount of bets that can be placed by the player are provided.

Additionally, as shown in FIG. 12, a win-or-loss display area 95 displaying whether or not the player wins for the bet is provided on the lower side of the chip display area 88. Here, if the player wins for the bet, a character string “YOU WON!” is displayed on the win-or-loss display area 95. Furthermore, a character string “YOU LOST!” is displayed on the win-or-loss display area 95 when the player loses for the bet.

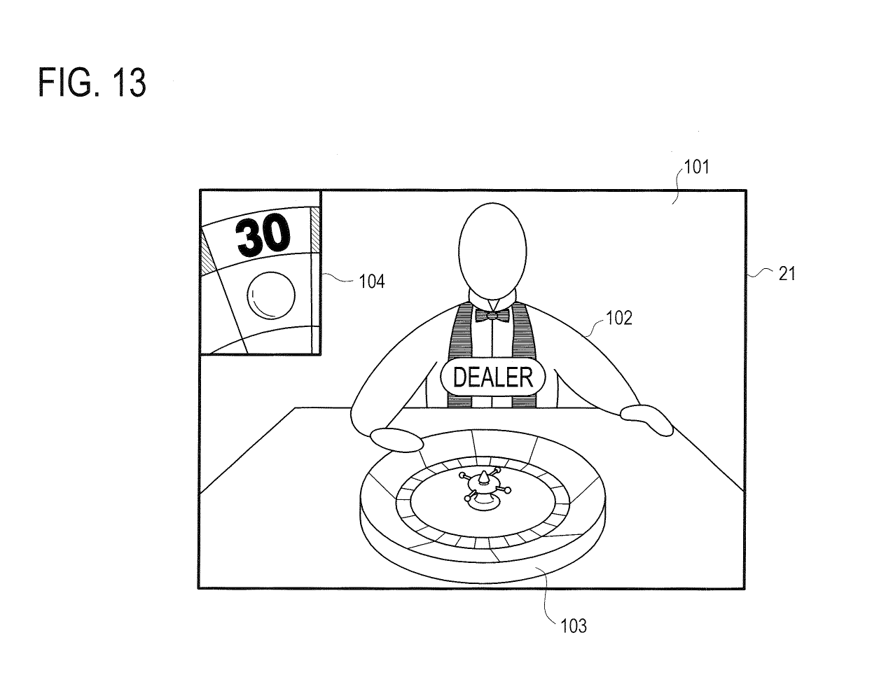

Next, a main screen 101 displayed on the front display 21 will be described referring to FIG. 13, when playing Roulette in the roulette gaming machine 1 according to the present embodiment.

FIG. 13 is a diagram showing the main screen 101 displayed on the front display 21. Here, with the roulette gaming machine 1 according to the present embodiment, images 102, 103 of the dealer animated to perform spinning of a wheel along the progress of the game or the like is displayed on the main screen 101 in order to improve the sense of reality of the game.

An enlarged image 104 of the pocket 71B, into which the ball 71C are fallen, is displayed on the upper left part of the main screen 101.

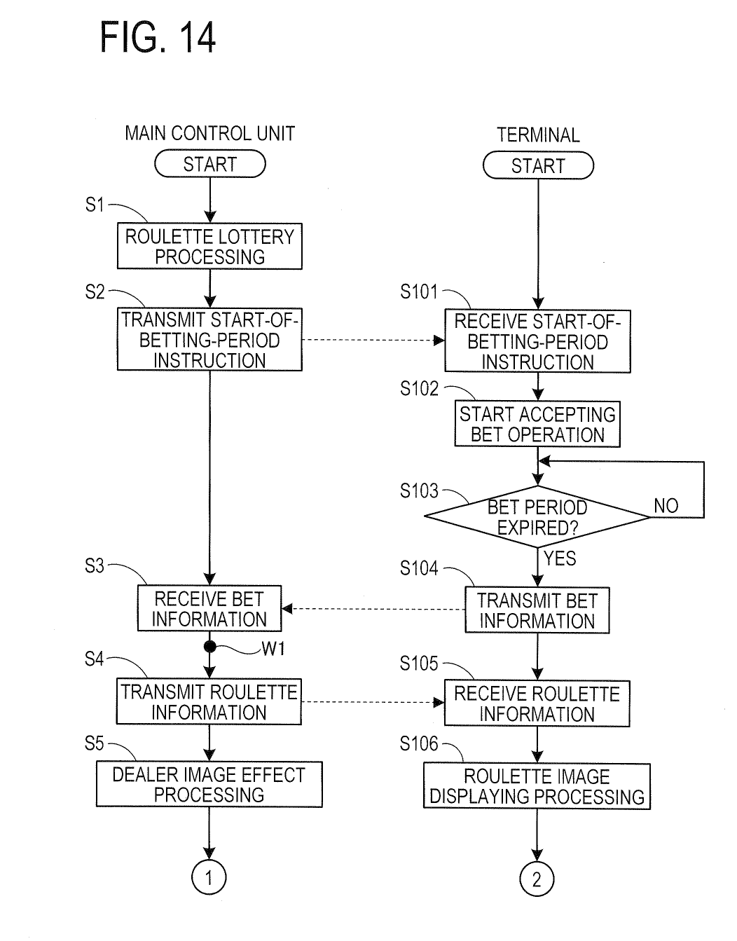

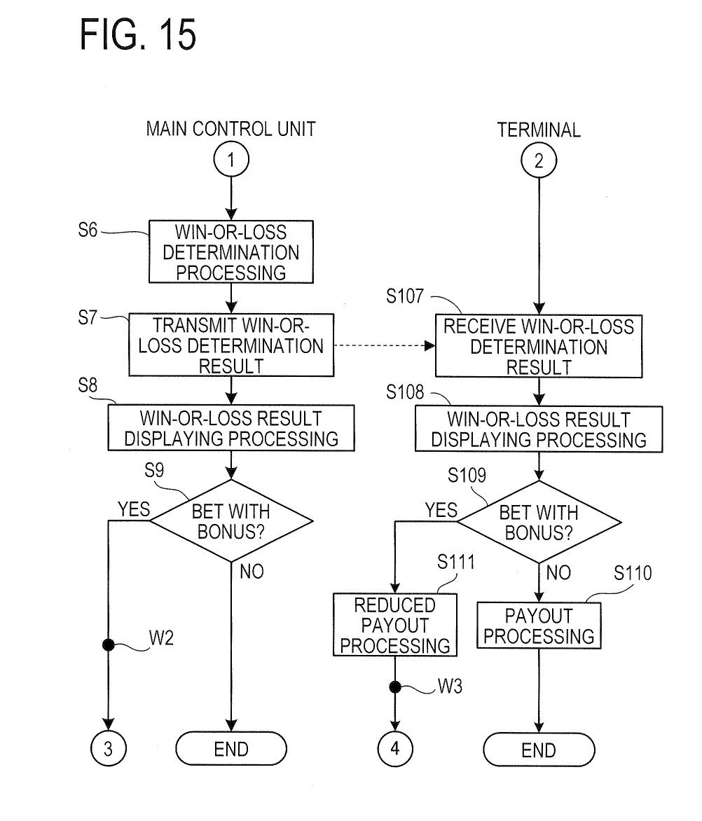

Next, a game processing program executed by the CPU 41 of the main control unit 31 and a game processing program at the terminal side executed by the CPU 51 of the terminal 4, respectively in the roulette gaming machine 1 according to the present embodiment, will be described, referring to FIGS. 14 and 15. Here, respective programs shown as a flow chart in FIGS. 14 and 15 are stored in the RAM 42 or the ROM 43 provided in the main control unit 31, or the RAM 52 or the ROM 53 provided in the terminal 4, and are executed by the CPU 41 or the CPU 51.

First, the game processing program executed by the main control unit 31 will be described, referring to FIGS. 14 and 15. In step (abbreviated to S hereafter) 1, the CPU 41 executes a roulette lottery processing to draw a number that are marked on the pocket 71B into which the ball 71C will be fallen on the wheel 71A. Specifically, a number within the range of 0 to 36 is associated with each one of numbers that were marked on the pockets 71B of the wheel 71A to be used in the game. Then, one of number within the range of 0 to 36 is drawn. A number that is marked the pocket 71B into which the ball 71C will be fallen on the wheel 71A is determined by the drawn number.

Subsequently, in S2, the CPU 41 transmits, to each of the terminals 4, an instruction to start a betting period for accepting the player's bet operation.

Next, in S3, the CPU 41 receives bet information transmitted from each of the terminals 4. Here, the bet information includes information relating to the amount of bets (number of credits) placed by the player and the player's bet target, or information relating to the type of bet (whether or not the bet operation has been performed using the bet-with-a-bonus button 201) placed by the player. In addition, the received bet information of each terminal 4 is temporarily stored in the RAM 42.

Subsequently, in S4, the CPU 41 transmits, to each of the terminals 4, roulette information (for example, information about the number that was marked on the pocket 71B into which the ball 71C will be fallen on the wheel 71A such as “1”, and the color that was colored to the pocket 71B into which the ball 71C will be fallen on the wheel 71A such as “Red”), based on the lottery result of the roulette lottery processing of S1. Then, in S5, the image 103 of the pocket 71B into which the thrown ball 71C will be fallen on the wheel 71A is displayed on the front display 21 as the main screen 101 (see FIG. 13). Here, the number that is marked on the pocket 71B into which the thrown ball 71C will be fallen on the wheel 71A, based on the lottery result of the roulette lottery processing of S1, are displayed.

Next, in S6, the CPU 41 compares a number that is marked to the pocket 71B into which the ball 71C will be fallen on the wheel 71A or the color that is colored to the pocket 71B into which the ball 71C will be fallen on the wheel 71A with the player's bet target and determines the win or loss. Since types of the numbers that are marked on the pockets 71B and types of the colors that are colored to the pockets 71B are well known, their explanation is omitted here.

Subsequently, in S7, the determination result of win or loss of S6 is transmitted to each of the terminals 4. Additionally, in S8, the CPU 41 displays, on the main screen 101 of the front display 21, an announcement image announcing the determination result of win or loss of each of the terminals 4.

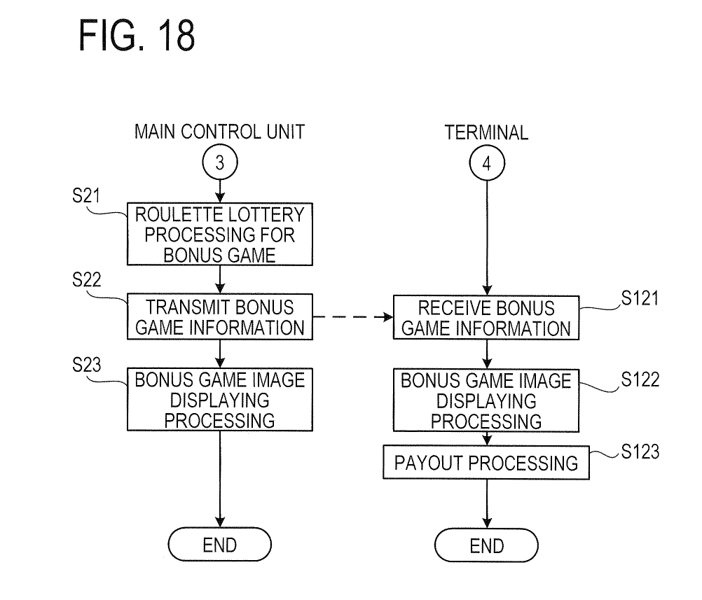

Furthermore, in S9, the CPU 41 determines whether or not a bet-with-a-bonus operation has been performed. The determination is based on the bet information received from each of the terminals 4, and it is determined that a bet-with-a-bonus operation has been performed when a bet has been placed using the bet-with-a-bonus button 201. Here, for a terminal 4 which is determined that no bet-for-a-bonus operation has been performed thereon (S9: NO), the game processing program terminates without doing anything. On the other hand, for a terminal 4 which is determined that a bet-with-a-bonus operation has been performed thereon (S9: YES), the process flow proceeds to a game processing program shown in FIG. 18 described below.

Next, the game processing program executed by the terminal 4 will be described, referring to FIGS. 14 and 15. In S101, the CPU 51 receives the instruction to start the betting period from the main control unit 31.

Subsequently, in S102, the CPU 51 displays the bet screen 70 (see FIGS. 1, 8, 10 and 12) on the liquid crystal display 10, and identifies the player's bet target and the amount of bets (the number of credits) which has been placed, based on operation information from the touch panel 11. In addition, the CPU 51 identifies the type of bet placed by the player (whether or not a bet operation has been performed using the bet-with-a-bonus button 201). Furthermore, the CPU 51 displays the images 72A and 72B of chips on the bet screen 70 in a distinct manner, based on the identified type of bet.

Next, in S103, the CPU 51 determines whether or not the betting period has expired. Specifically, it is determined whether or not a predefined time length (e.g. 20 see) has passed since accepting the bet operation was started in S102.

If it is determined that the betting period has not expired (S103: NO), accepting the bet operation is continued. If, on the other hand, it is determined that the betting period has expired (S103: YES), the process flow proceeds to S104.

In S104, the CPU 51 transmits the bet information to the main control unit 31. Here, the bet information includes the information relating to the amount of bets (the number of credits) placed by the player and the player's bet target, or the information relating to the type of bet (whether or not the bet operation has been performed using the bet-with-a-bonus button 201) placed by the player.

Additionally, in S105, the CPU 51 receives the roulette information (information such as the pocket 71B into which the ball 71C will be fallen on the wheel 71A) from the main control unit 31. Then, in S106, the CPU 51 displays, on the bet screen 70, the pocket 71B into which the ball 71C is fallen on the wheel 71A, based on the roulette information received in S105. Here, the wheel 71A displayed in S106 are displayed as a series of images (see FIG. 6). In the series of images, the wheel 71A is spinning, the ball 71C is thrown, the ball 71C is falling into one of the pockets 71B, and the wheel 71A is stopping.

Subsequently, in S107, the CPU 51 receives the determination result of win or loss transmitted from the main control unit 31. Then, in S108, the CPU 51 displays, on the liquid crystal display 10, the determination result of win or loss of the player who is playing at the terminal 4, based on the determination result of win or loss received in S107. Specifically, a character string “YOU WON!” is displayed on the win-or-loss display area 95 of the bet screen 70 (see FIG. 12) when the player wins for the bet. Furthermore, a character string “YOU LOST!” is displayed when the player loses for the bet.

Subsequently, in S109, the CPU 51 determines whether or not a bet-with-a-bonus operation has been performed, based on the bet information transmitted in S104.

Here, also in this determination, it is determined that a bet-with-a-bonus operation has been performed when a bet has been placed using the bet-with-a-bonus button 201.

Then, if it is determined that no bet-with-a-bonus operation has been performed (S109: NO), an ordinary payout is made. Specifically, credits multiplied the odds of the player's bet target by the amount of bets (number of credits) which has been placed are paid to the player if the player wins for the bet (S110). Subsequently, the game processing program executed by the CPU 51 of the terminal 4 is terminated.

If, on the other hand, it is determined that a bet-with-a-bonus operation has been performed (S109: YES), payout is made with the amount of the award changed from the case of S110. Specifically, credits 0.7 times the number of credits multiplied the odds of the player's bet target by the amount of bets (number of credits) which has been placed are paid to the player if the player wins for the bet (S111). Then the process flow proceeds to the game processing program shown in FIG. 18 described below.

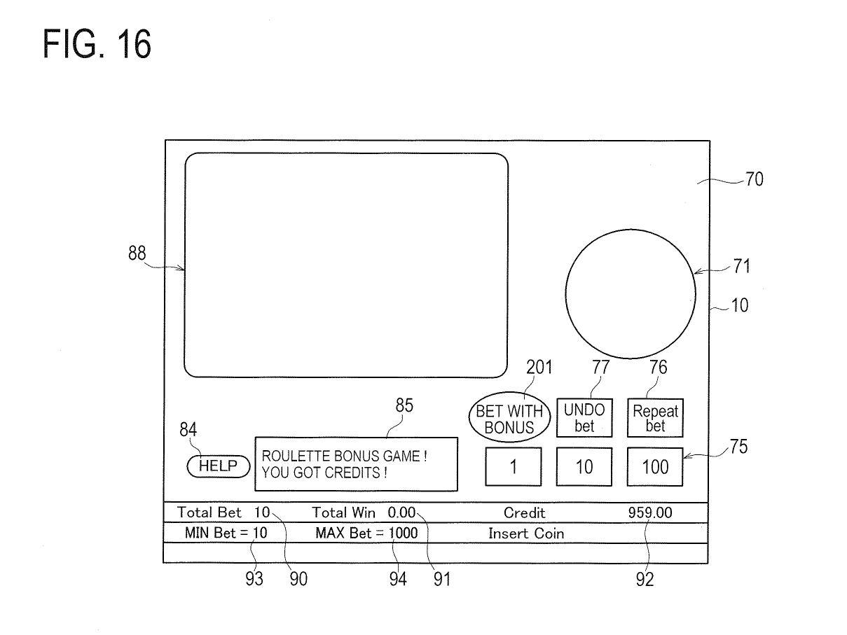

Next, the bet screen 70 displayed on the liquid crystal display 10 of the terminal 4 when executing the bonus game in the roulette gaming machine 1 according to the present embodiment will be described, referring to FIG. 16. FIG. 16 shows the bet screen 70 displayed on the liquid crystal display 10 of the terminal 4 when executing the bonus game. Here, with the roulette gaming machine 1 according to the present embodiment, when the bonus game is executed subsequent to Roulette, one of number is drawn from 37 numbers (from “0” to “36”) that are marked on each of the pockets 71B respectively. The drawn number is displayed shiny on the betting board 88A, as shown in FIG. 17, on the chip display area 88 of the bet screen 70. Then, the number, which is displayed shiny on the betting board 88A, of credits is paid to the player. Messages “ROULETTE BONUS CHANCE GAME! YOU GOT CREDITS!” are displayed on the message area 85 of the bet screen 70, as shown in FIG. 16.

Next, with regard to the bonus game which has been executed subsequent to Roulette, a game processing program executed by the CPU 41 of the main control unit 31 and a game processing program at the terminal side executed by the CPU 51 of the terminal 4, respectively, in the roulette gaming machine 1 according to the present embodiment will be described, referring to FIG. 18. Here, respective programs shown as a flow chart in FIG. 18 are stored in the RAM 42 or the ROM 43 provided in the main control unit 31, or the RAM 52 or the ROM 53 provided in the terminal 4, and are executed by the CPU 41 or the CPU 51.

First, the game processing program executed by the main control unit 31 will be described, referring to FIG. 18. The main control unit 31 executes the game processing program for the terminal 4 which is determined in S9 of the above-mentioned FIG. 15 that a bet-with-a-bonus operation has been performed thereon (S9: YES). In S21, the CPU 41 executes a roulette lottery processing for a bonus game to draw a number which are displayed shiny on the betting board 88A. Specifically, one of number within the range of 0 to 36 is associated with each one of 37 numbers (from “0” to “36”) to be used in the bonus game. Then, one of number within the range of 0 to 36 is drawn. The one of number which are displayed shiny on the betting board 88A is determined by the drawn number.

Subsequently, in S22, the CPU 41 transmits, to the terminal 4, bonus game information relating to the number which are displayed shiny on the betting board 88A to the player who is playing the bonus game at the terminals 4 (for example, information about the number such as “23”), based on the lottery result of the roulette lottery processing for a bonus game of S21. Then, in S23, the image of the betting board on which the number including the bonus game information is displayed on the front display 21 as the main screen 101 (see FIG. 12).

In this manner, with regard to the bonus game which has been executed subsequent to Roulette, the game processing program executed by the CPU 41 of the main control unit 31 is terminated.

Next, the game processing program executed by the terminal 4 will be described, referring to FIG. 18. In S121, the CPU 51 receives, from the main control unit 31, the bonus game information relating to the number which are displayed shiny on the betting board 88A (for example, information about the number such as “23”). Then, in S122, the CPU 51 displays shiny, on the betting board 88A on the chip display area 88 of the bet screen 70, the number to be included in the bonus game information. Here, the number displayed shiny in S122 are displayed as a series of images (see FIG. 17). In the series of images, an only number is displayed shiny after all numbers flashed on and off.

Furthermore in S122, the CPU 51 displays a character string “ROULETTE BONUS CHANCE GAME! YOU GOT CREDITS!” on the message area 85 of the bet screen 70, as shown in FIG. 16.

Then, in S123, the CPU 51 executes a payout processing to add and store, in the RAM 53, the number of credits included as data in the bonus game information received in S121, and provide it to the player.

In this manner, with regard to the bonus game which has been executed subsequent to Roulette, the game processing program executed by the CPU 51 of the terminal 4 is terminated.

Note that the present invention is not limited to the above examples, and various kinds of improvement or modification are possible without deviating from the scope of the present invention.

For example, in the present embodiment, the number of credits provided to the player who won in the bonus game may be fixed to the maximum amount of credits (36) or the like. Furthermore, if the player wins in the bonus game, the player may acquires a payout in the bonus game. In this regard, it is determined that whether or not the player wins in the bonus game by the color (Red•Black•Green) that was colored to the pocket 71B into which the ball 71C was fallen on the wheel 71A in the main game of Roulette.

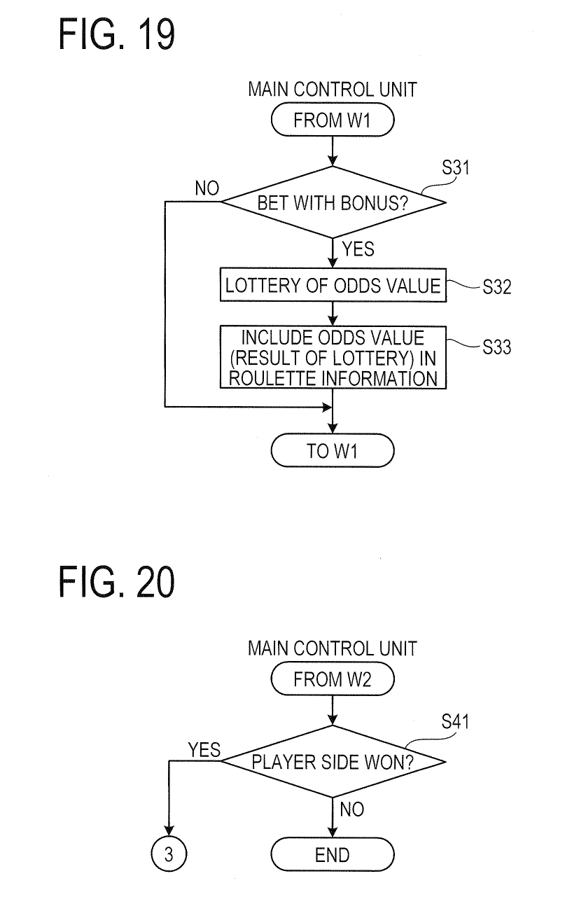

Additionally, in Roulette with the present embodiment, when the player indicates the amount of bets using the bet-with-a-bonus button 201, the odds for which may be changed (it is fixed at an ordinary value x0.7 in the above example). Therefore, it may be arranged such that, for example, the main control unit 31 executes a game processing program shown in FIG. 19 at a time point W1 located in the middle between S3 and S4 of the game processing program shown in FIG. 14. In other words, when the bet information is received by S3 of the game processing program shown in FIG. 14, the process flow proceeds to S31 of the game processing program shown in FIG. 19 where the CPU 41 of the main control unit 31 determines whether or not a bet-with-a-bonus operation has been performed. This determination is based on the bet information received from each of the terminals 4, and it is determined that a bet-with-a bonus operation has been performed if a bet operation has been performed using the bet-with-a-bonus button 201. Here, for a terminal 4 which is determined that no bet-for-a-bonus operation has been performed thereon (S31: NO), the process flow returns to the game processing program shown in FIG. 14 and proceeds to S4 without doing anything. On the other hand, for a terminal 4 which is determined that a bet-with-a-bonus operation has been performed thereon (S31: YES), the process flow proceeds to S32.

In S32, the CPU 41 acquires, by lottery, a numerical formula within the range of x0.1 to x1.0. The lottery may be executed either by hardware or software. Subsequently, in S33, the CPU 41 includes the numerical formula acquired in S32 into the roulette information (see S4 of FIG. 14), then the process flow returns to the game processing program shown in FIG. 14 and proceeds to S4.

In this manner, when the main control unit 31 executes the game processing program shown in FIG. 19, the CPU 51 of each of the terminals 4 displays, in S106 of the game processing program shown in FIG. 14, the numerical formula included in the roulette information on the message area 85 of the bet screen 70. For example, if the numerical formula included in the roulette information is x0.5, a character string “BET WITH BONUS IS INDICATED! YOUR ODDS LOWER WITH x0.7x0.5. YOU WILL HAVE A BONUS GAME!” is displayed on the message area 85 of the bet screen 70. Furthermore, when the process flow proceeds to S111 of the game processing program shown in FIG. 15, the CPU 51 of each of the terminals 4 executes payout of an award based on the numerical formula included in the roulette information.

In addition, the present embodiment may be limited such that the bonus game executed subsequent to Roulette is executed only if the player side wins for the player's bet in Roulette.

Therefore, it may be arranged such that, for example, the main control unit 31 executes a game processing program shown in FIG. 20 at a time point W2 located in the middle between S9 of the game processing program shown in FIG. 15 and S21 of the game processing program shown in FIG. 18. In other words, for the terminal 4 which is determined, in S9 of the game processing program shown in FIG. 15, that a bet-with-a-bonus operation has been performed thereon (S9: YES), the process flow proceeds to S41 of FIG. 20 where the CPU 41 determines whether or not the player side has won for the player's bet in Roulette at the terminal 4. The determination is based on the determination result of win or loss in S7 of the game processing program shown in FIG. 15. Here, if it is determined that the player side has won for the player's bet in Roulette of the terminal 4 (S41: YES), the process flow proceeds to S21 of the game processing program shown in FIG. 18, and the CPU 41 executes the bonus game at the terminal 4. If, on the other hand, it is determined that the player side has not won (defeat) for the player's bet in Roulette at the terminal 4 (S41: NO), the main control unit 31 subsequently terminates the game processing program.

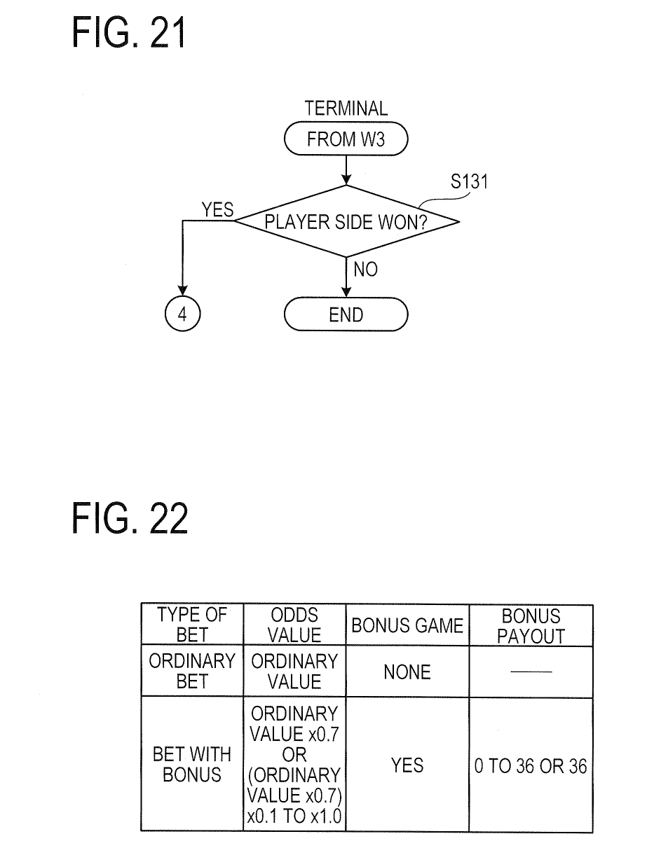

Furthermore, it may be arranged such that, for example, each of the terminals 4 executes a game processing program shown in FIG. 21 at a time point W3 located in the middle between S111 of the game processing program shown in FIG. 15 and S121 of the game processing program shown in FIG. 18. In other words, for the terminal 4 which is determined, in S109 of the game processing program shown in FIG. 15, that a bet-with-a-bonus operation has been performed thereon (S109: YES), the process flow proceeds to S131 of FIG. 21 via the reduced payout processing of S111, where the CPU 51 determines whether or not the player side has won for the player's bet in Roulette at the terminal 4. The determination is based on the determination result of win or loss received in S108 of the game processing program shown in FIG. 15. Here, if it is determined that the player side has won for the player's bet in Roulette of the terminal 4 (S131: YES), the process flow proceeds to S121 of the game processing program shown in FIG. 18, and the CPU 41 executes the bonus game. If, on the other hand, it is determined that the player side has not won (defeat) for the player's bet in Roulette at the terminal 4 (S131: NO), the game processing program executed by the terminal 4 is subsequently terminated.

In this manner, if the main control unit 31 executes the game processing program shown in FIG. 20 and if each of the terminals 4 executes the game processing program shown in FIG. 21, the bonus game executed subsequent to Roulette is executed only on the terminal 4 at which the player side won in Roulette.

Additionally, with the present embodiment, the roulette gaming machine 1 which executes Roulette and the bonus game may be a gaming machine on which the above-mentioned control unit 31 and the terminal 4 are integrated.

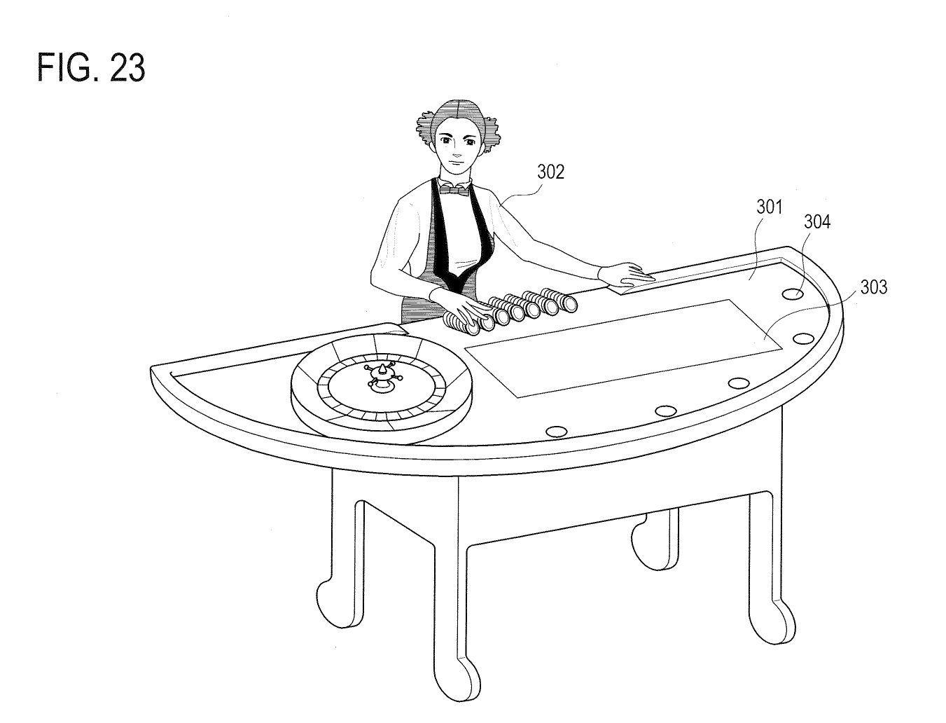

In addition, the playing method of Roulette according to the present invention can also be applied to Roulette (so-called table game) played by the dealer 302 and the player (not shown) on a gaming table 301, as shown in FIG. 23.

In the table game shown in FIG. 23, the dealer 302 prepares a wheel, a ball and so like when playing Roulette and, on the gaming table 301, throws the ball onto the spun wheel. The player places a bet by putting chips on a betting board 303 of the gaming table 301. In this occasion, if chips are further put on a particular spot 304 adjacent to the betting board 303, the dealer 302 determines that a bet-with-a-bonus operation has been performed. However, the dealer 302 may also determine that a bet-with-a-bonus operation has been performed if special chips are put on the betting board 303.

In addition, the dealer 302 throws the ball in the spun wheel again when playing the bonus game.

Here, the actual game playing method is similar to that of the roulette gaming machine 1 except that the dealer 302 performs throwing the ball onto the spun wheel directly.

As described above, with the roulette gaming machine 1 and playing method of Roulette according to the present embodiment, there are an ordinary bet operation using only the bet button 75 without using the bet-with-a-bonus button 201, and a bet-with-a-bonus operation using both the bet-with-a-bonus button 201 and the bet button 75, as the bet operation of Roulette. In this regard, FIG. 22 is a table showing the difference between the ordinary bet operation and the bet-with-a-bonus operation.

If an ordinary bet operation is performed in Roulette, the odds value is the ordinary value (different in every bet spots related to the number and the color of pockets 71B) fixed and no bonus game will be executed subsequent to Roulette, as shown in FIG. 22.

If, on the other hand, a bet-with-a-bonus operation is performed in Roulette, the odds value is fixed to the ordinary value x0.7 or varied within the range of the ordinary value x0.7 x0.1 to the ordinary value x0.7 x1.0. However, the ordinary value is different in every bet spots related to the numbers which are marked on pockets 71B and the colors which are colored to the pockets 71B. Furthermore, the bonus game is executed subsequent to Roulette, and a variable number of 0 to 36 credits or a fixed maximum amount of payout (36) will be awarded as a bonus payout to the winner of the bonus game. Here, an additional condition such that the player has to win for the player's bet in Roulette may be posed in order to execute the bonus game subsequent to Roulette.

What is claimed is:

1. A gaming machine comprising:
a display device for displaying a ball used in a main game, a wheel including a plurality of pockets where a number is marked respectively and the ball is fallen, and an odds table including a plurality of bet spots, on which the numbers marked on the pockets are marked respectively;
an operation unit for allowing a player to indicate the number of bets of one of a first type and a second type for any of the bet spots;
a memory for storing the number of credits held by the player; and
a processor programmed to execute the main game by executing processes of:
when the number of bets of the first type is indicated by an operation on the operation unit,
(a) displaying on the display device that the ball is thrown onto the spun wheel and is fallen into one of the pockets, upon completion of the player's performing the operation of indicating the number of bets using the operation unit;
(b) determining whether or not the player side wins, based on the number which is marked on the pocket into which the ball is fallen which have been displayed on the display device; and
(c) if it is determined that the player side wins, adding the number of credits calculated using a predefined odds to the number of credits in the memory and storing the sum, when, otherwise, the number of bets of the second type is indicated by an operation on the operation unit,
(d) changing the odds to a lower value than the predefined odds and executing the main game;
(e) randomly determining whether or not to award a bonus to the player; and
(f) if it is determined to award the bonus to the player, adding the number of credits according to the bonus to the number of credits in the memory and storing the sum.

2. The gaming machine according to claim 1, wherein
the processor is programmed to randomly determine whether or not to award the bonus to the player by executing processes of:
(a) executing the main game in a condition of dividing the pockets into a plurality of groups including a predefined group previously; and
(b) determining to award the bonus to the player, if the predefined group includes the pocket into which the ball is fallen which has been displayed on the display device.

3. The gaming machine according to claim 1, wherein
the processor is programmed to add the number of credits according to the bonus to the number of credits in the memory and storing the sum by executing processes of:
(a) flashing a number, that is determined randomly out of each number which is marked on the pockets, on the odds table of the display device; and
(b) adding the number of credits same as the determined number to the number of credits in the memory and storing the sum.

4. The gaming machine according to claim 1, wherein
the processor is programmed to randomly determine whether or not to award the bonus to the player by executing processes of:
(a) separately from the main game, determining to award the bonus to the player.

5. A game playing method comprising, so as to make a main game proceed, the steps of: when a player indicates the number of bets of a first type for any of a plurality of bet spots included on an odds table,
(a) throwing a ball onto a spun wheel and being fallen into one of pockets of the wheel, upon completion of the player's indicating the number of bets;
(b) determining whether or not the player side wins, based on a number which is marked on the pocket into which the ball is fallen; and
(c) if it is determined that the player side wins, awarding the number of credits calculated using a predefined odds to the player, when, otherwise, the player indicates the number of bets of the second type for any of a plurality of bet spots included on the odds table,
(d) changing the odds to a lower value than the predefined odds and executing the main game;
(e) randomly determining whether or not to award a bonus to the player; and
(f) if it is determined to award the bonus to the player, awarding the number of credits according to the bonus to the player.

6. The game playing method according to claim 5 comprising the steps of: so as to randomly determine whether or not to award the bonus to the player,
(a) executing the main game in a condition of dividing the pockets into a plurality of groups including a predefined group previously; and
(b) determining to award the bonus to the player, if the predefined group includes the pocket into which the ball is fallen.

7. The game playing method according to claim 5 comprising the steps of: so as to award the bonus to the player by executing processes of:
(a) announcing a number that is determined randomly out of each number which is marked on the pockets; and
(b) awarding the number of credits same as the determined number to the player.

8. The game playing method according to claim 5 comprising the steps of: so as to randomly determine whether or not to award the bonus to the player,
(a) separately from the main game, determining to award the bonus to the player.
